(19) United States
(12) Patent Application Publication
(10) Pub. No.: US 2026/0089260 A1
(43) Pub. Date: Mar. 26, 2026

(54) INTELLIGENT CALL CENTER CONSULTATION SYSTEM AND METHOD

(71) Applicant: ELECTRONICS AND TELECOMMUNICATIONS RESEARCH INSTITUTE, Daejeon (KR)

(72) Inventor: Jin-Xia HUANG, Daejeon (KR)

(21) Appl. No.: 18/955,038

(22) Filed: Nov. 21, 2024

(30) Foreign Application Priority Data
Sep. 24, 2024 (KR) 10-2024-0128692

(51) Int. Cl. H04M 3/51

(52) U.S. Cl. CPC H04M 3/5166

(57) ABSTRACT

Provided are an intelligent call center consultation system and method which automatically perform some of consultation business that is performed by human consultants. The intelligent call center consultation system includes a user reception unit configured to receive a voice or text input from a user terminal, an intelligent consultation unit configured to automatically generate a consultation response to a user inquiry, a consultant transceiver unit configured to perform the transmission and reception of information to and from a consultant terminal, a response provision unit configured to provide the user terminal with a response that is automatically generated by the intelligent consultation unit and a response of the human consultant from the consultant transceiver unit.

### CROSS-REFERENCE TO RELATED APPLICATION(S)

This application claims priority to and the benefit under 35 USC § 119 of Korean Patent Application No. 10-2024-0128692 filed on Sep. 24, 2024, in the Korean Intellectual Property Office, the entire disclosure of which is incorporated herein by reference for all purposes.

### BACKGROUND

### 1. Technical Field

The present disclosure relates to a call center consultation system and method based on artificial intelligence and to an intelligent call center consultation system and method which automatically perform some of consultation business that is conventionally performed by human consultants.

### 2. Description of Related Art

All types of consultation are handled by human consultants in a call center, but customer consultation services are gradually provided through an automatic consultation system, such as an automatic response system (ARS) or an AI call center (AICC). However, an automatic call center system so far does not provide natural consultation services, such as those provided by human consultants, because the automatic call center system provides response services in a way that the automatic call center system provides several service candidates to a customer after receiving a request from the customer and the customer selects a desired service or menu among the several service candidates. In particular, when a user expresses his or her intent, the user does not frequently express the intent explicitly and accurately as a keyword that is requested by the automatic call center system. In such a case, the provision of an automatic consultation service may fail.

In order to solve such a problem, a conventional automatic consultation system allows a user to autonomously select one of pieces of predetermined intent when there is ambiguity in analyzing the intent of the user and provides a predetermined response based on the intent selected by the user.

Furthermore, if the response candidate provided by the conventional automatic consultation system is not a response that is requested by the user, the user has to perform the consultation process from the beginning, and nevertheless, the user often has a difficulty in finding an accurate service. Furthermore, although the user is connected to a human consultant because an automatic response fails, the user has to perform related consultation again from the beginning. As described above, the conventional automatic consultation system does not form an efficient collaboration structure with a human consultant and does not provide an efficient consultation service to a customer.

Furthermore, the conventional automatic consultation system does not use a case in which an automatically generated response does not satisfy a customer in automatically improving system performance by recognizing the case at the right moment.

### SUMMARY

Various embodiments are directed to providing a user with a natural and efficient intelligent consultation service, such as that provided by human consultants, through an artificial intelligence call center consultation service.

Furthermore, various embodiments are directed to providing an efficient consultation service by rapidly understanding the intent of a user in a way that a consultation system generates a proactive question through active prediction with respect to intent that is not explicitly expressed by the user in addition to analyzing intent that is explicitly expressed by the user.

Furthermore, various embodiments are directed to providing an intelligent consultation system and method capable of efficiently collaborating with a human consultant.

Furthermore, various embodiments are directed to providing an intelligent consultation system and method having a self-learning function.

An intelligent call center consultation system according to an embodiment of the present disclosure includes a user reception unit configured to receive a voice or text input from a user terminal, an intelligent consultation unit configured to automatically generate a consultation response to a user inquiry, a consultant transceiver unit configured to perform a transmission and reception of information to and from a consultant terminal, a response provision unit configured to provide the user terminal with a response that is automatically generated by the intelligent consultation unit and a response of the human consultant from the consultant transceiver unit, a ranking response storage unit configured to store two or more responses that are rankable with respect to a request from an identical user when the two or more responses are present, and a reinforced learning unit configured to train a compensation model of the intelligent consultation unit by using the two or more responses.

In an embodiment, the intelligent consultation unit includes a user intent prediction unit configured to analyze and predict the intent of a user from a user input, a task generation unit configured to generate a task that needs to be performed by the intelligent call center consultation system based on the intent of the user generated by the user intent prediction unit, and a response generation unit configured to generate a system response based on information of the task received from the task generation unit and dialogue information and to provide the system response to the response provision unit. The dialogue information may include a dialogue history that is a dialogue record between the user and the intelligent call center consultation system and a dialogue state including information of the intent of the user that is output by the user intent prediction unit and the information of the task that is output by the task generation unit.

In an embodiment, the user intent prediction unit includes a slot tagging prediction unit configured to tag a slot value that is specified in the user input and to generate a slot type, by using a slot tagging corpus and an intent analysis prediction unit configured to generate the intent of the user, based on the slot value generated by the slot tagging prediction unit and a service classification corpus from the slot type. The user intent prediction unit may operate in a dynamic cyclic pipeline way to predict and generate the slot value that is not explicitly expressed in the user input by transmitting results of the intent analysis prediction unit to the slot tagging prediction unit once again when the intent of the user is not clearly revealed in the slot tagging.

In an embodiment, the task may include a clarification question task for actively understanding the intent of the user. The intent analysis prediction unit may transmit, to the slot tagging prediction unit, results that are predicted by analyzing and predicting the intent of the user and a part that needed to be checked, with respect to contents that need to be checked because the intent is not explicitly expressed. The slot tagging prediction unit may generate the slot type and the slot value including the predicted results from the input of the intent analysis prediction unit and the part that needs to be checked. The task generation unit may generate the clarification question task including the predicted results and the part that needs to be checked.

In an embodiment, the user intent prediction unit may further include a knowledge search unit configured to search for knowledge that is necessary for consultation dialogues with reference to the dialogue information and to provide the task generation unit with the retrieved knowledge along with the dialogue information. The task generation unit may generate one of detailed tasks that need to be performed by the intelligent call center consultation system, based on the information provided by the knowledge search unit.

In an embodiment, the intelligent consultation unit further includes a summarization unit. The task generation unit may generate a summarization task when an intervention of the human consultant is required and transmit the summarization task to the summarization unit. The summarization unit may generate a consultation dialogue summary by summarizing consultation dialogue contents from the dialogue information up to now and transmit the consultation dialogue summary to the consultant transceiver unit. The consultant transceiver unit may transmit the consultation dialogue summary to the consultant terminal.

In an embodiment, a case in which the two or more responses that are rankable are present with respect to the request from the identical user may include a case in which a request proceeds to a next request because an automatically generated response of the intelligent consultation unit with respect to a user request is not accepted by a user and an automatically generated response of the intelligent consultation unit is received once again and accepted by the user and a case in which a dialogue continues to a response of the human consultant through the consultant transceiver unit because an automatically generated response of the intelligent consultation unit with respect to a user request is not accepted by the user.

In an embodiment, the ranking response storage unit includes a ranking response determination unit configured to collect a ranking response. The ranking response determination unit determines a case in which the user input may include a consent expression after an expression of denial intent with respect to a system response in a dialogue history of dialogue information to be a rankable response.

In an embodiment, the intelligent consultation unit may be implemented with one unified intelligent consultation model capable of executing multi-tasking, which is obtained by training a pre-trained large language model (LLM) or an LLM for code generation by using data, including user intent prediction data, task generation data, tagged dialogue data that generate a dialogue response from the dialogue information, tagged summarization data that generate summarization from dialogue information, dialogue data not having tagging information and consisting of a pair of a user input and a system response, and summarization data not having tagging information and consisting of dialogues and summarization in an instruction tuning way.

An intelligent call center consultation method according to an embodiment of the present disclosure includes an inquiry input step of receiving a voice or text input from a user terminal, a response generation step of automatically generating a consultation response to a user inquiry, a response provision step of an automatically generated response to a user terminal, a ranking response storage step of storing two or more responses that are rankable with respect to a request from an identical user when the two or more responses are present, and a reinforced learning step of training a compensation model by using the two or more responses.

The response generation step may include a user intent prediction step of analyzing and predicting the intent of a user from a user input, a task generation step of generating a task that needs to be performed by an intelligent call center consultation system based on the intent of the user, and a system response generation step of generating a system response based on information of the task and dialogue information.

In an embodiment, the dialogue information includes a dialogue history that is a dialogue record between the user and the intelligent call center consultation system and a dialogue state including information of the intent of the user and the information of the task.

In an embodiment, the user intent prediction step includes a slot tagging prediction step of tagging a slot value that is specified in the user input and generating a slot type, by using a slot tagging corpus and an intent analysis prediction step of generating the intent of the user, based on the slot value generated in the slot tagging prediction step and a service classification corpus from the slot type. The user intent prediction step operates in a dynamic cyclic pipeline way to predict and generate the slot value that is not explicitly expressed in the user input by performing the slot tagging prediction step once again based on results of the intent analysis prediction step when the intent of the user is not clearly revealed in the slot tagging.

In an embodiment, the task may include a clarification question task for actively understanding the intent of the user. In the intent analysis prediction step, results that are predicted by analyzing and predicting the intent of the user and a part that needed to be checked are generated with respect to contents that need to be checked because the intent is not explicitly expressed. In the slot tagging prediction step, the slot type and the slot value including the predicted results and the part that needs to be checked are generated. In the task generation step, the clarification question task including the predicted results and the part that needs to be checked may be generated.

In an embodiment, the user intent prediction step may include a step of searching for knowledge that is necessary for consultation dialogues with reference to the dialogue information. The task generation step includes generating one of detailed tasks that need to be performed by the intelligent call center consultation system based on the retrieved information and the dialogue information.

In an embodiment, the task generation step includes a step of generating a summarization task when an intervention of the human consultant is required. When the summarization task is generated, a consultation dialogue summary that is obtained by summarizing consultation dialogue contents from the dialogue information up to now may be generated and transmitted to a consultant terminal.

In an embodiment, a case in which the two or more responses that are rankable are present with respect to the request from the identical user may include a case in which a request proceeds to a next request because an automatically generated response of the intelligent consultation step with respect to a user request is not accepted by a user and an automatically generated response of the intelligent consultation step is received once again and accepted by the user and a case in which a dialogue continues to a response of the human consultant through the consultant transceiver step because an automatically generated response of the intelligent consultation step with respect to a user request is not accepted by the user.

In an embodiment, the ranking response storage step may include a ranking response determination step of collecting a ranking response. The ranking response determination step includes determining a case in which the user input may include a consent expression after an expression of denial intent with respect to a system response in a dialogue history of dialogue information to be a rankable response.

In an embodiment, the intelligent consultation step may be implemented with one unified intelligent consultation model capable of executing multi-tasking, which is obtained by training a pre-trained large language model (LLM) or an LLM for code generation by using data, including user intent prediction data, task generation data, tagged dialogue data that generate a dialogue response from the dialogue information, tagged summarization data that generate summarization from dialogue information, dialogue data not having tagging information and consisting of a pair of a user input and a system response, and summarization data not having tagging information and consisting of dialogues and summarization in an instruction tuning way.

An embodiment of the present disclosure can provide an intelligent consultation service to a user by understanding the user's intent through a proactive question when the user's expression is ambiguous or the intent of the user is unclear through the analysis and prediction of user needs through dialogues and with reference to related product information.

Furthermore, according to an embodiment of the present disclosure, smooth consultation can be continued by determining timing at which the intervention of a human consultant is required by autonomously recognizing the limit of automatic consultation, automatically generating summarization information up to that time, and automatically handing over consultation business to the human consultant.

Furthermore, an embodiment of the present disclosure can continuously improve intelligent consultation performance through reinforced learning by automatically determining and storing two or more responses that are rankable as ranking response data when the two or more responses correspond to a request from the same user during dialogues.

The unified intelligent consultation model that is proposed by the present disclosure can be trained in a multi-task learning way by implementing pipeline module components, such as user intent analysis, system speech act analysis, and response generation in the existing consultation system, with one unified consultation model. This can reduce development and maintenance costs, and may also be an efficient construction in the improvement of performance through reinforced learning.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a functional block diagram illustrating a construction of an intelligent call center consultation system according to an embodiment of the present disclosure.

FIG. 2 is a functional block diagram illustrating a detailed construction and input and output flowchart of an intelligent consultation unit.

FIG. 3 is a diagram for describing a dynamic cyclic pipeline in a user intent prediction unit.

FIG. 4 is an exemplary diagram of an input and output flow of a task generation unit.

FIG. 5 is a functional block diagram illustrating a construction of a ranking response storage unit according to an embodiment of the present disclosure.

FIG. 6 illustrates an input and output flow of an embodiment in which an intelligent consultation unit is implemented with a unified intelligent consultation model.

FIG. 7 is an example of an intelligent consultation flow when the intent of a user is explicitly revealed in a user input.

FIG. 8 exemplarily illustrates an intelligent consultation flow according to an embodiment of the present disclosure when the intent of a user is not explicitly revealed in a user input.

FIG. 9 exemplarily illustrates a conventional intelligent consultation flow when the intent of a user is not explicitly revealed in a user input.

FIG. 10 exemplarily illustrates a flow of efficient task prediction and generation and consultation service provision through knowledge search according to an embodiment of the present disclosure.

FIG. 11 is an example of a conventional consultation service provision flow for a comparison with the efficient task prediction and generation and consultation service provision flow of FIG. 10.

FIG. 12 is an example in which ranking responses are collected through a ranking response determination unit.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

Embodiments of the present disclosure relate to a consultation system and method based on artificial intelligence. The intelligent consultation system provides a smooth intelligent consultation service by predicting the intent of a user through user intent analysis and prediction that operate as a dynamic cyclic pipeline when an expression of the user is ambiguous or the intent of the user is not clear in dialogues, predicting and generating a task through knowledge search, and understanding the intent of the user through a proactive question.

The intelligent consultation system according to an embodiment of the present disclosure provides a smooth AI-human collaboration intelligent consultation service that automatically determines that the intervention of a human consultant is required and that automatically hands over consultation business to the human consultant along with summarization information, when automatic consultation is impossible due to poor communication, such as an error of the prediction of the intent of a user in automatic consultation dialogues, or the continuous provision of responses not required by the user or when a service required by a user is a service which can be processed by only a human consultant. Embodiments of the present disclosure can provide an efficient and satisfactory consultation service so that a user does not need to start consultation dialogues again from the beginning, by autonomously recognizing a case in which the intelligent consultation system does not provide a satisfactory service to the user, automatically generating consultation summarization information when there is a good possibility that automatic consultation will fail, and handing over the consultation summarization information to a human consultant.

The intelligent consultation system according to an embodiment of the present disclosure can automatically identify and store two or more rankable responses that are made to a request from the same user when the two or more rankable responses occur, and can continuously improve performance of an intelligent consultation unit through reinforced learning in a self-learning way.

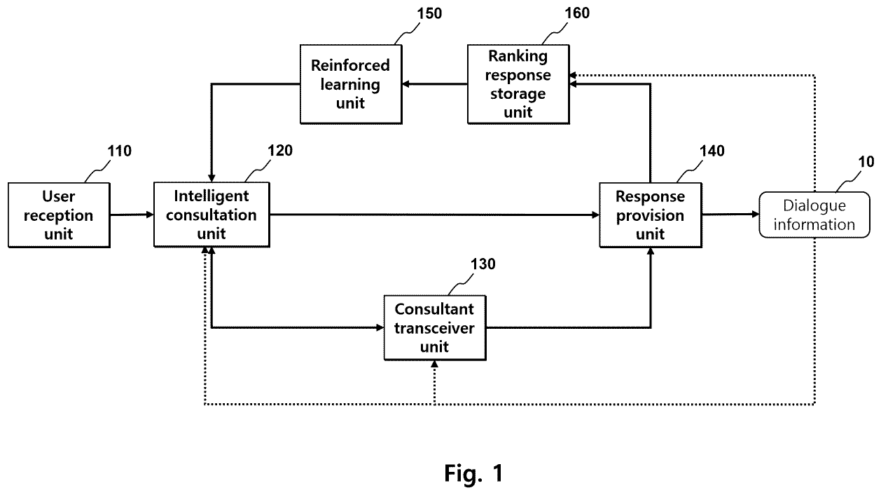

FIG. 1 is a functional block diagram illustrating a construction of an intelligent call center consultation system according to an embodiment of the present disclosure.

A user reception unit 110 receives a voice or text input from a user terminal. In the case of a voice input, the user reception unit 110 may recognize the voice and convert the voice into text.

An intelligent consultation unit 120 automatically generates a consultation response to a user inquiry, summarizes dialogues up to that time when the intervention of a human consultant is required, and provides the summarized dialogues to a consultant transceiver unit 130. The consultant transceiver unit 130 performs the transmission and reception of information to and from a consultant terminal that is used by a human consultant. The consultant transceiver unit 130 transmits, to the consultant terminal, summarization received from the intelligent consultation unit 120, receives a response of the human consultant from the consultant terminal, and transmits the response to a response provision unit 140. The response provision unit 140 that has received the response automatically generated by the intelligent consultation unit 120 and the response of the human consultant from the consultant transceiver unit 130 provides the received responses to the user terminal in the form of text or a voice.

A dialogue record between a user and the intelligent call center consultation system is called a dialogue history. The dialogue history is stored as dialogue information 10 along with a dialogue state, that is, the output of the intelligent consultation unit. The dialogue history includes both automatically generated responses by the intelligent consultation unit 120 and dialogues of a human consultant through the consultant transceiver unit 130 in addition to a user input through the user reception unit 110. Reference may be made to the dialogue information 10 in the intelligent consultation unit 120, the consultant transceiver unit 130, and the ranking response storage unit 160.

When two or more responses (e.g., an automatically generated response and a consultant response or two or more automatically generated responses) that are rankable are present with respect to a request from the same user, the two or more responses are stored in a ranking response storage unit 160, thereby continuously improving performance of the intelligent consultation unit 120 through a reinforced learning unit 150. That is, performance of the intelligent consultation unit 120 is continuously improved through self-learning.

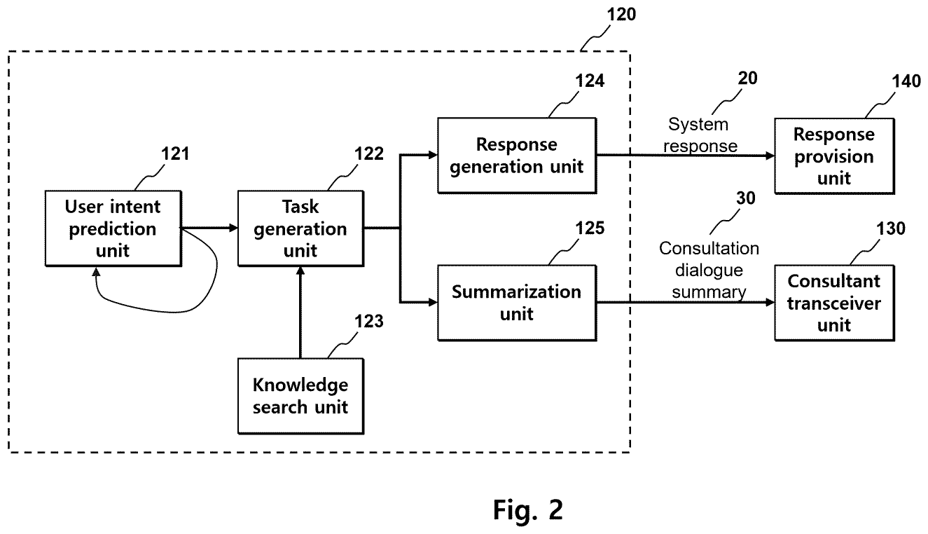

FIG. 2 is a functional block diagram illustrating a detailed construction and input and output flowchart of the intelligent consultation unit 120. A user intent prediction unit 121 analyzes and predicts the intent of a user from a user input. A task generation unit 122 generates a task that needs to be performed by the intelligent call center consultation system. The knowledge search unit 123 searches for knowledge that is necessary for consultation dialogues with reference to the dialogue information 10, and provides the retrieved knowledge to the task generation unit 122 along with the dialogue information 10.

Slot tagging that is output by the user intent prediction unit 121, user intent information including the results of the analysis of the intent of a user, and task information that is output by the task generation unit 122 constitute a “dialogue state”. The dialogue state is stored as the dialogue information 10 along with a dialogue history.

A task that is output the task generation unit 122 includes a human consultant intervention task. The task generation unit 122 transmits a human consultant intervention task to the summarization unit 125, when it is determined that the intervention of a human consultant is required based on the dialogue information 10, such as the repeated denial of a user or the expressions of complaints. The summarization unit 125 generates consultation dialogue summary 30 and outputs the consultation dialogue summary 30 to the consultant transceiver unit 130.

That is, when the intervention of the human consultant is required, the task generation unit 122 outputs “summarization” as a task. The task is transmitted to the summarization unit 125. The summarization unit 125 generates the consultation dialogue summary 30 by summarizing consultation dialogue contents from the dialogue information 10 up to now. The generated consultation dialogue summary 30 is transmitted to the consultant transceiver unit 130. A consultant can immediately continue consultation dialogues through simple check without the need to ask user information again from the beginning because the consultant can check summarization up to now, so that an efficient consultation service can be provided. The dialogue state and dialogue history of the dialogue information 10, other than a summarization task, is transmitted to the response generation unit 124 along with task type information, thereby generating a system response 20.

A task that is executed includes tasks which may be automatically executed. The task generation unit 122 transmits task information capable of being automatically executed to a response generation unit 124. The dialogue state and dialogue history of the dialogue information 10, along with the task type information, are transmitted to the response generation unit 124. The response generation unit 124 generates the system response 20 based on the received task information and the dialogue information 10, and outputs the system response 20 to the response provision unit 140.

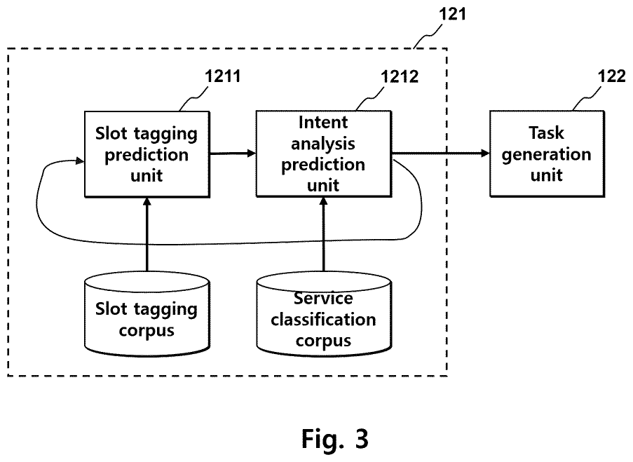

The user intent prediction unit 121 in FIG. 2 operates in a dynamic cyclic pipeline way. A detailed construction diagram of the user intent prediction unit 121 is illustrated in FIG. 3. A slot tagging prediction unit 1211 tags a slot value that is specified in a user input by using a slot tagging corpus, and generates a slot type. An intent analysis prediction unit 1212 generates the intent of a user, based on the generated slot value and a service classification corpus from the slot type.

If the intent of a user is not clearly revealed in slot tagging, but can be analyzed and predicted, in an embodiment of the present disclosure, slot information that is not explicitly expressed by the user is automatically predicted and generated. That is, the results of the intent analysis prediction unit 1212 are transmitted to the slot tagging prediction unit 1211 once again, if necessary, so that the slot tagging prediction unit 1211 generates a slot value that is not explicitly expressed in a user input through prediction. The intent of the user is transmitted to the task generation unit 122. The task generation unit 122 generates a system task based on the intent of the user.

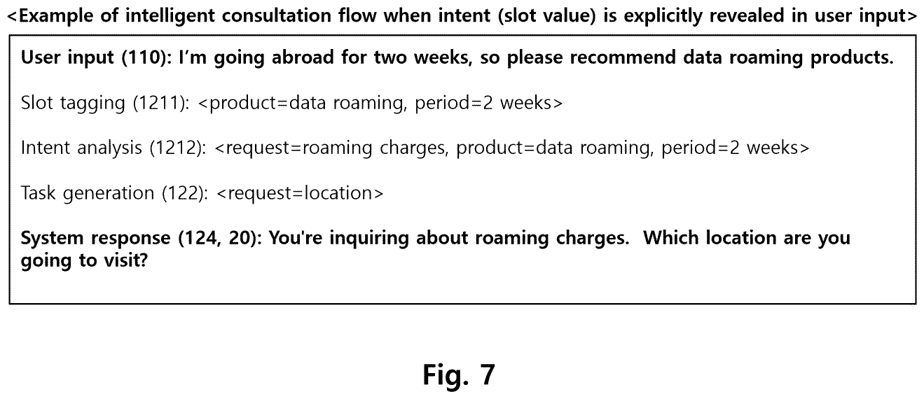

Such an operation is described as an example. FIG. 7 is an example of an intelligent consultation flow when the intent of a user is explicitly revealed in a user input.

When a user input 110 “I'm going abroad for two weeks, so please recommend data roaming products” is spoken, a slot value (e.g., data roaming) is explicitly included. The slot tagging prediction unit 1211 tags the slot value specified in the user input and generates a slot type (e.g., a product). The intent analysis prediction unit 1212 generates the intent (e.g., request=roaming charges) of the user based on the generated slot value and slot type. The task generation unit 122 outputs a system speech act (e.g., request=location) as a task. Accordingly, the response generation unit 124 outputs the system response 20. The contents so far are portions in which the same function may be generally performed even in an automatic consultation dialogue technology using a conventional user intent understanding technology, and may be considered as providing an accurate response because the type of a user can be analyzed when the user clearly expresses his or her intent as an accurate keyword.

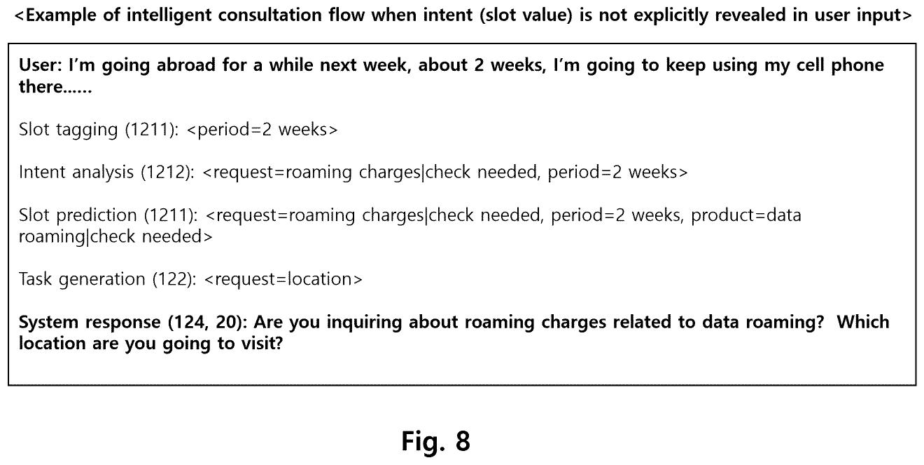

FIG. 8 exemplarily illustrates an intelligent consultation flow according to an embodiment of the present disclosure when the intent of a user is not explicitly revealed in a user input. A mention relating to a period is present in a user input “I'm going abroad for a while next week, about 2 weeks, I'm going to keep using my cell phone there . . . ”, but the intent of the user has not been explicitly expressed. The slot tagging prediction unit 1211 derives results <period=2 weeks>. The intent analysis prediction unit 1212 outputs results “<request=roaming charges|check needed, period=2 weeks>” by performing the analysis and prediction of the intent based on the derived results <period=2 weeks>. The output of the results “<request=roaming charges|check needed, period=2 weeks>” is transmitted to the slot tagging prediction unit 1211 again. The slot tagging prediction unit 1211 predicts and generates a slot type and slot value (e.g., “product=data roaming|check needed”) which may be estimated although they are not clearly expressed by the user. Accordingly, the task generation unit 122 generates a task “<request=location>”. The response generation unit 124 smoothly performs next consultation dialogues by generating a proactive question, such as “Are you inquiring about roaming charges related to data roaming? Which location are you going to visit? ”, with respect to contents that need to be checked based on the generated task.

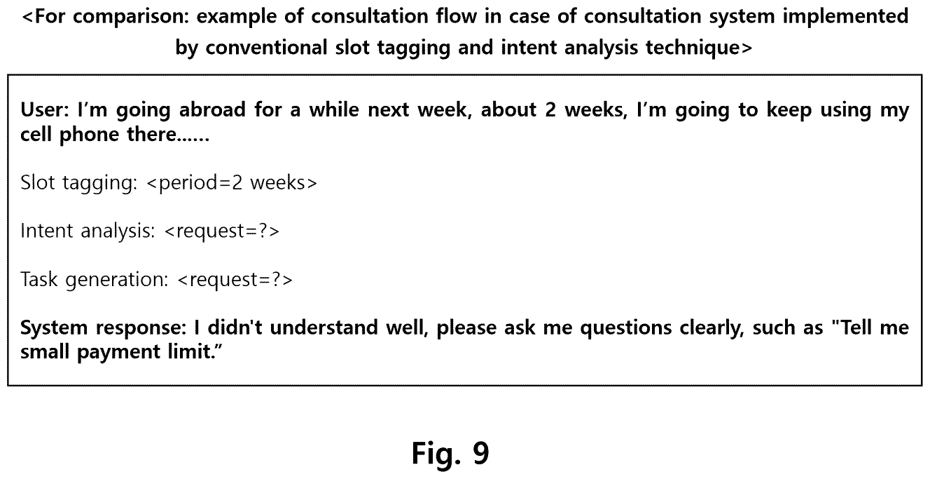

For a comparison with the generation of a response according to an embodiment of the present disclosure, an example of a response in a conventional consultation dialogue system when the same user input as that shown in the example of FIG. 8 is provided is illustrated in FIG. 9.

When the intent of a user is not explicitly revealed in a user input, the conventional consultation dialogue system requests the user to input request contents more clearly once again as illustrated in FIG. 9. From FIG. 9, it may be seen that when a user does not know the exact name of the service and only provides a description of the situation, human consultants can often infer the user's intent, but conventional automated consultation dialogue systems fail to analyze the intent because the relevant keywords are not included in the user input, leading to a failure in providing accurate consultation.

Slot types, such as “period” and “product”, the intent of a user, such as “request”, and a task in the example of FIG. 9 are merely examples for convenience of description, and a method of expressing them may be various like a “period”, a “service (product)”, and a “request”.

Furthermore, the task type that is output by the task generation unit 122 may be various. In addition to a typical system speech act, such as <request=location> (<request=location>), which is illustrated in the examples, arithmetic, such as a count, a sum, and multiplication, are also possible. Task types, such as various function execution API calls, a clarification question for actively understanding the intent of a user, the generation of a response to be provided to a user, a help, and summarization when the intervention of a human consultant is required, may be variously defined when a consultation service is required.

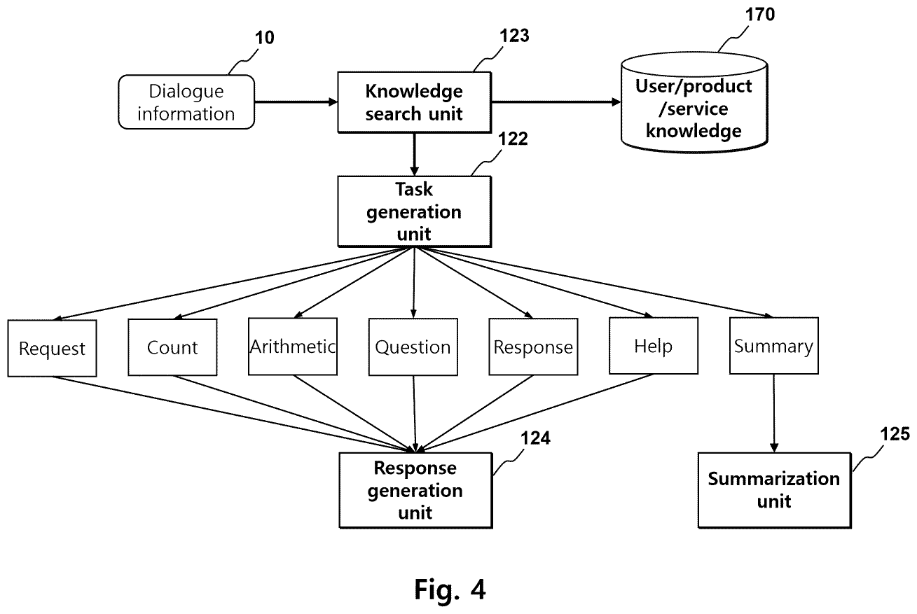

An input and output flow of the task generation unit 122 is exemplarily described with reference to FIG. 4. A knowledge search unit 123 searches user/product/service knowledge 170 having various formats, such as a DB, a table, text, or a document, for knowledge that is necessary for consultation dialogues with reference to the dialogue information 10, and provides the retrieved knowledge to the task generation unit 122 along with the dialogue information 10. The task generation unit 122 generates one of detailed tasks that need to be performed by the intelligent call center consultation system based on the provided information. User information of the user/product/service knowledge 170 illustrated in FIG. 4 may also include information on a product that is subscribed by a user and service information, such as a recently received product inquiry. The task generation unit 122 predicts and generates a task based on such service information.

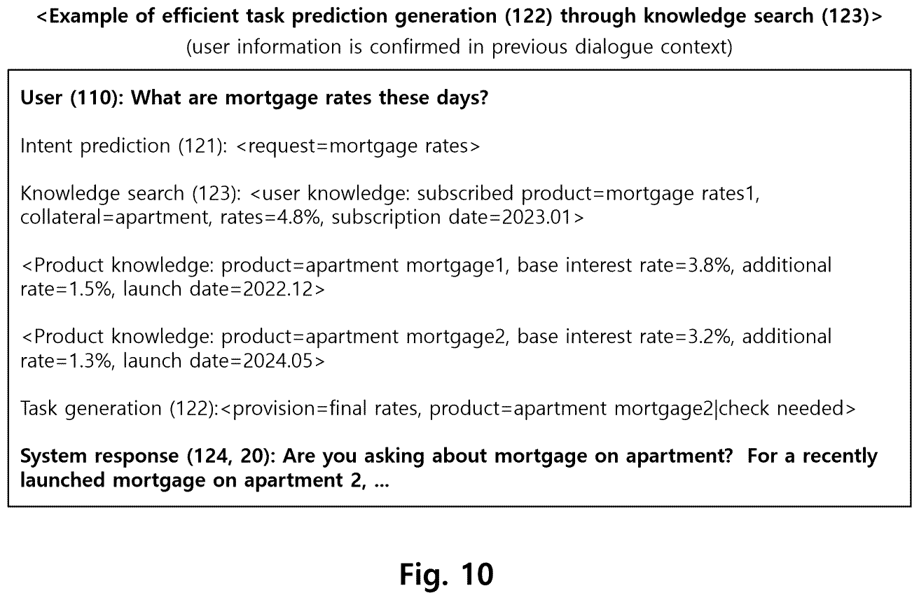

FIG. 10 illustrates an example of efficient task prediction generation and consultation service provision flow through knowledge search according to an embodiment of the present disclosure. When a user asks about mortgage rates, the intelligent call center consultation system according to an embodiment of the present disclosure immediately presents a response that asks whether the question of the user is a question related to an apartment mortgage and a response that provides information on a new apartment mortgage without an additional question procedure, based on the product subscribed by the user and checked in the previous dialogue history, information on collateral, and information on a mortgage product that is obtained through knowledge search.

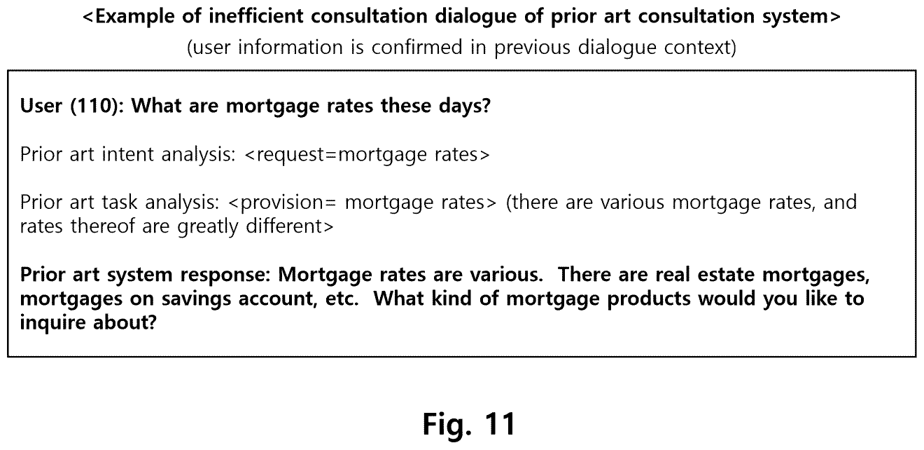

FIG. 11 illustrates an example in which a consultation service is not smooth in a conventional consultation service for a comparison with the present disclosure. In the example of FIG. 10, a consultation service is efficiently performed through the prediction of a task through knowledge search. However, in the example of a conventional consultation system illustrated in FIG. 11, a consultation service is relatively inefficiently performed, such as that an additional question is required, because only a task that is explicitly expressed by a user can be analyzed.

The task generation unit 122 may be trained by fine-tuning a large language model (LLM) like a common generation model training method, butt may be trained in a way to fine-tune a language model for code generation in order to improve accuracy. The present disclosure is not limited to a specific base language model to be fine-tuned.

The response generation unit 124 and the summarization unit 125 may be obtained by training a pretrained language model separately by consultation dialogue data and summarization data, respectively, may be obtained by constructing or training an independent purpose orientation and knowledge-based dialogue model and a summarization model, respectively, and may be made to generate responses or generate summary according to a few-shot learning method based on a small amount of examples and instructions with respect to an LLM. The present disclosure is not limited to specific constructions of the response generation unit 124 and the summarization unit 125.

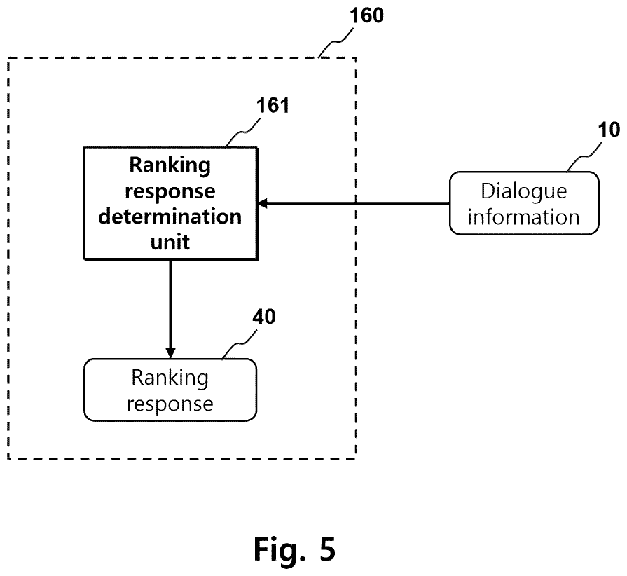

A construction the ranking response storage unit 160 according to an embodiment of the present disclosure is described below with reference to FIG. 5. When two or more responses that are rankable are present with respect to a request from the same user, the two or more responses are stored in the ranking response storage unit 160 and are used to train a compensation model of the reinforced learning unit 150.

A case in which two or more responses that are rankable are present with respect to a request from the same user is as follows.
1) A case in which a request proceeds to a next request because an automatically generated response of the intelligent consultation unit 120 with respect to a user request is not accepted by a user and an automatically generated response of the intelligent consultation unit 120 is received once again and accepted by the user.
2) A case in which a dialogue continues to a response of a human consultant through the consultant transceiver unit 130 because an automatically generated response of the intelligent consultation unit 120 with respect to a user request is not accepted by the user.

A ranking response determination unit 161 is a criterion for determining a rankable response to a request from the same user, and may be implemented to accept a user input, such as “that is right”, again after an expression of denial intent, such as “not that”, in the dialogue history of the dialogue information 10, with respect to a system response, to determine a user input based on information, such as the update of dialogue state information, but to train a classification model or a generation model based on related data.

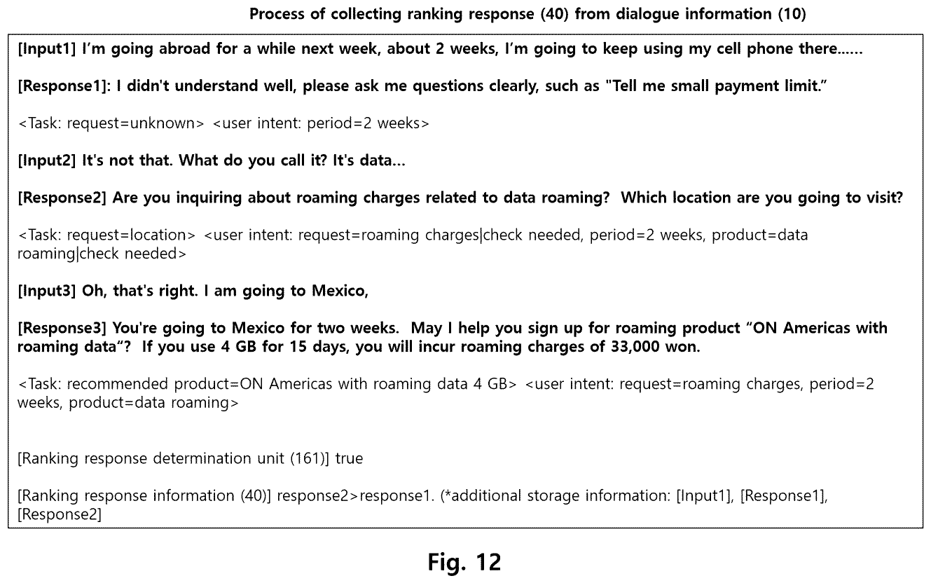

The ranking response determination unit 161 of the ranking response storage unit 160 operates in real time as the dialogue information 10 is updated. A ranking response 40 that is stored is used to train the compensation model of the reinforced learning unit 150 that operates based on a designated period or a designated amount of data collected, and is finally used for the reinforced training of the intelligent consultation unit 120. An example in which the ranking response 40 is collected through the ranking response determination unit 161 is illustrated in FIG. 12.

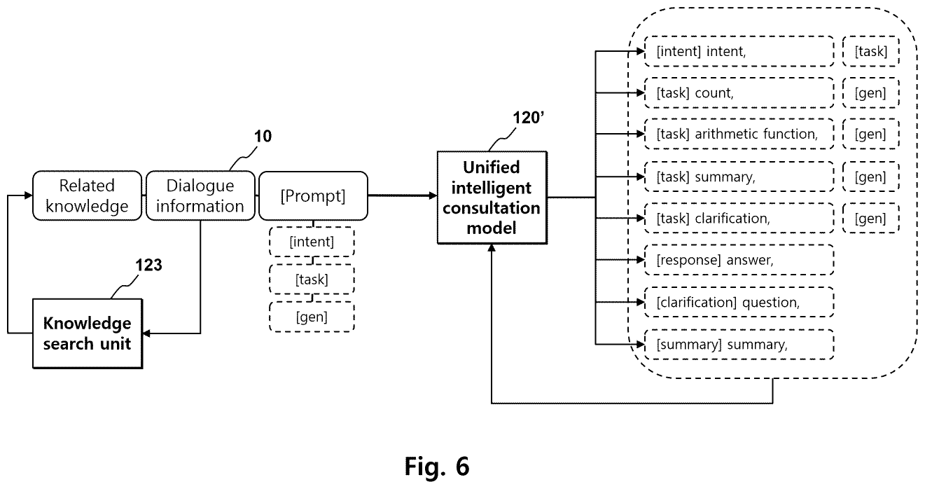

In an embodiment, the intelligent consultation unit 120 may be implemented by training a unified intelligent consultation model. FIG. 6 illustrates an input and output flow of an embodiment in which the intelligent consultation unit is implemented with a unified intelligent consultation model.

A pre-trained LLM or an LLM for code generation may be trained as one unified intelligent consultation model capable of executing multi-tasking by training the pre-trained LLM or the LLM for code generation by using various data, such as user intent prediction data, task generation data, tagged dialogue data that generate dialogue responses from dialogue information, tagged summarization data that generate summarization from dialogue information, dialogue data (not having tagging information) consisting of a pair of a user input and a system response, and summarization data (not having tagging) consisting of a dialogue and summarization in an instruction tuning way.

Knowledge that is related to consultation dialogues that are retrieved with reference to the dialogue information 10 in the knowledge search unit 123 is provided to a unified intelligent consultation model 120′ along with the dialogue information 10. The unified intelligent consultation model 120′ generates next prompts ([task], [gen]) along with information, such as user intent (intent), a system task (task), a response for an answer (response answer), a response for a question (clarification question), and a summary (summary), based on an input prompt and related information.

When a next prompt is not present, the output of the unified intelligent consultation unit 120′ is transmitted to the response provision unit 140 or the consultant transceiver unit 130. When a next prompt is present, the prompt is input to the unified intelligent consultation model 120′ as an input, and is repeatedly referred until a response or summary is generated.

As still another embodiment of the unified intelligent consultation model 120 of FIG. 6, the model is trained by using the same data and same instruction tuning method as those described above, but may be constructed to immediately generate a response to a user input by designating one prompt, that is, “[gen]”in the reference.

The method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

### DESCRIPTION OF REFERENCE NUMERALS

110: user reception unit, 120: intelligent consultation unit, 121: user intent prediction unit, 122: task generation unit, 123: knowledge search unit, 124: response generation unit, 125: summarization unit, 130: consultant transceiver unit, 140: response provision unit, 150: reinforced learning unit, 160: ranking response storage unit.

What is claimed is:

1. An intelligent call center consultation system comprising:
a user reception unit configured to receive a voice or text input from a user terminal;
an intelligent consultation unit configured to automatically generate a consultation response to a user inquiry;
a consultant transceiver unit configured to perform a transmission and reception of information to and from a consultant terminal;
a response provision unit configured to provide the user terminal with a response that is automatically generated by the intelligent consultation unit and a response of the human consultant from the consultant transceiver unit;
a ranking response storage unit configured to store two or more responses that are rankable with respect to a request from an identical user when the two or more responses are present; and
a reinforced learning unit configured to train a compensation model of the intelligent consultation unit by using the two or more responses.

2. The intelligent call center consultation system of claim 1, wherein the intelligent consultation unit comprises:
a user intent prediction unit configured to analyze and predict an intent of a user from a user input;
a task generation unit configured to generate a task that needs to be performed by the intelligent call center consultation system based on the intent of the user generated by the user intent prediction unit; and
a response generation unit configured to generate a system response based on information of the task received from the task generation unit and dialogue information and to provide the system response to the response provision unit,
wherein the dialogue information comprises a dialogue history that is a dialogue record between the user and the intelligent call center consultation system and a dialogue state comprising information of the intent of the user that is output by the user intent prediction unit and the information of the task that is output by the task generation unit.

3. The intelligent call center consultation system of claim 2, wherein the user intent prediction unit comprises:
a slot tagging prediction unit configured to tag a slot value that is specified in the user input and to generate a slot type, by using a slot tagging corpus; and
an intent analysis prediction unit configured to generate the intent of the user, based on the slot value generated by the slot tagging prediction unit and a service classification corpus from the slot type,
wherein the user intent prediction unit operates in a dynamic cyclic pipeline way to predict and generate the slot value that is not explicitly expressed in the user input by transmitting results of the intent analysis prediction unit to the slot tagging prediction unit once again when the intent of the user is not clearly revealed in the slot tagging.

4. The intelligent call center consultation system of claim 3, wherein:
the task comprises a clarification question task for actively understanding the intent of the user,
the intent analysis prediction unit transmits, to the slot tagging prediction unit, results that are predicted by analyzing and predicting the intent of the user and a part that needed to be checked, with respect to contents that need to be checked because the intent is not explicitly expressed,
the slot tagging prediction unit generates the slot type and the slot value comprising the predicted results from the input of the intent analysis prediction unit and the part that needs to be checked, and
the task generation unit generates the clarification question task comprising the predicted results and the part that needs to be checked.

5. The intelligent call center consultation system of claim 2, wherein:
the user intent prediction unit further comprises a knowledge search unit configured to search for knowledge that is necessary for consultation dialogues with reference to the dialogue information and to provide the task generation unit with the retrieved knowledge along with the dialogue information, and
the task generation unit generates one of detailed tasks that need to be performed by the intelligent call center consultation system, based on the information provided by the knowledge search unit.

6. The intelligent call center consultation system of claim 2, wherein:
the intelligent consultation unit further comprises a summarization unit,
the task generation unit generates a summarization task when an intervention of the human consultant is required and transmits the summarization task to the summarization unit,
the summarization unit generates a consultation dialogue summary by summarizing consultation dialogue contents from the dialogue information up to now and transmits the consultation dialogue summary to the consultant transceiver unit, and
the consultant transceiver unit transmits the consultation dialogue summary to the consultant terminal.

7. The intelligent call center consultation system of claim 1, wherein a case in which the two or more responses that are rankable are present with respect to the request from the identical user comprises:
a case in which a request proceeds to a next request because an automatically generated response of the intelligent consultation unit with respect to a user request is not accepted by a user and an automatically generated response of the intelligent consultation unit is received once again and accepted by the user, and
a case in which a dialogue continues to a response of the human consultant through the consultant transceiver unit because an automatically generated response of the intelligent consultation unit with respect to a user request is not accepted by the user.

8. The intelligent call center consultation system of claim 1, wherein:
the ranking response storage unit comprises a ranking response determination unit configured to collect a ranking response, and
the ranking response determination unit determines a case in which the user input comprises a consent expression after an expression of denial intent with respect to a system response in a dialogue history of dialogue information to be a rankable response.

9. The intelligent call center consultation system of claim 1, wherein the intelligent consultation unit is implemented with one unified intelligent consultation model capable of executing multi-tasking, which is obtained by training a pre-trained large language model (LLM) or an LLM for code generation by using data, comprising user intent prediction data, task generation data, tagged dialogue data that generate a dialogue response from the dialogue information, tagged summarization data that generate summarization from dialogue information, dialogue data not having tagging information and consisting of a pair of a user input and a system response, and summarization data not having tagging information and consisting of dialogues and summarization in an instruction tuning way.

10. An intelligent call center consultation method comprising:
an inquiry input step of receiving a voice or text input from a user terminal;
a response generation step of automatically generating a consultation response to a user inquiry;
a response provision step of an automatically generated response to a user terminal;
a ranking response storage step of storing two or more responses that are rankable with respect to a request from an identical user when the two or more responses are present; and
a reinforced learning step of training a compensation model by using the two or more responses.

11. The intelligent call center consultation method of claim 10, wherein the response generation step comprises:
a user intent prediction step of analyzing and predicting an intent of a user from a user input;
a task generation step of generating a task that needs to be performed by an intelligent call center consultation system based on the intent of the user; and
a system response generation step of generating a system response based on information of the task and dialogue information,
wherein the dialogue information comprises a dialogue history that is a dialogue record between the user and the intelligent call center consultation system and a dialogue state comprising information of the intent of the user and the information of the task.

12. The intelligent call center consultation method of claim 11, wherein the user intent prediction step comprises:
a slot tagging prediction step of tagging a slot value that is specified in the user input and generating a slot type, by using a slot tagging corpus; and
an intent analysis prediction step of generating the intent of the user, based on the slot value generated in the slot tagging prediction step and a service classification corpus from the slot type,
wherein the user intent prediction step operates in a dynamic cyclic pipeline way to predict and generate the slot value that is not explicitly expressed in the user input by performing the slot tagging prediction step once again based on results of the intent analysis prediction step when the intent of the user is not clearly revealed in the slot tagging.

13. The intelligent call center consultation method of claim 12, wherein:
the task comprises a clarification question task for actively understanding the intent of the user,
in the intent analysis prediction step, results that are predicted by analyzing and predicting the intent of the user and a part that needed to be checked are generated with respect to contents that need to be checked because the intent is not explicitly expressed,
in the slot tagging prediction step, the slot type and the slot value comprising the predicted results and the part that needs to be checked are generated, and
in the task generation step, the clarification question task comprising the predicted results and the part that needs to be checked is generated.

14. The intelligent call center consultation method of claim 11, wherein:
the user intent prediction step comprises a step of searching for knowledge that is necessary for consultation dialogues with reference to the dialogue information, and
the task generation step comprises generating one of detailed tasks that need to be performed by the intelligent call center consultation system based on the retrieved information and the dialogue information.

15. The intelligent call center consultation method of claim 11, wherein:
the task generation step comprises a step of generating a summarization task when an intervention of the human consultant is required, and
when the summarization task is generated, a consultation dialogue summary that is obtained by summarizing consultation dialogue contents from the dialogue information up to now is generated and transmitted to a consultant terminal.

16. The intelligent call center consultation method of claim 10, wherein a case in which the two or more responses that are rankable are present with respect to the request from the identical user comprises:
a case in which a request proceeds to a next request because an automatically generated response of the intelligent consultation step with respect to a user request is not accepted by a user and an automatically generated response of the intelligent consultation step is received once again and accepted by the user, and
a case in which a dialogue continues to a response of the human consultant through the consultant transceiver step because an automatically generated response of the intelligent consultation step with respect to a user request is not accepted by the user.

17. The intelligent call center consultation method of claim 11, wherein:
the ranking response storage step comprises a ranking response determination step of collecting a ranking response, and
the ranking response determination step comprises determining a case in which the user input comprises a consent expression after an expression of denial intent with respect to a system response in a dialogue history of dialogue information to be a rankable response.

18. The intelligent call center consultation method of claim 10, wherein the intelligent consultation step is implemented with one unified intelligent consultation model capable of executing multi-tasking, which is obtained by training a pre-trained large language model (LLM) or an LLM for code generation by using data, comprising user intent prediction data, task generation data, tagged dialogue data that generate a dialogue response from the dialogue information, tagged summarization data that generate summarization from dialogue information, dialogue data not having tagging information and consisting of a pair of a user input and a system response, and summarization data not having tagging information and consisting of dialogues and summarization in an instruction tuning way.
